(19) United States
(12) Patent Application Publication
(10) Pub. No.: US 2016/0261334 A1
(43) Pub. Date: Sep. 8, 2016

(54) MULTILAYER-BASED MULTIBEAM SATELLITE COMMUNICATION SYSTEM AND SIGNAL TRANSMISSION METHOD USING THE SAME

(71) Applicant: Electronics and Telecommunications Research Institute, Daejeon (KR)

(72) Inventor: Hee Wook KIM, Daejeon (KR)

(21) Appl. No.: 15/060,903

(22) Filed: Mar. 4, 2016

(30) Foreign Application Priority Data
Mar. 6, 2015 (KR) 10-2015-0031553

(51) Int. Cl. H04B 7/185; H04B 7/04

(52) U.S. Cl. CPC H04B 7/18513; H04B 7/0413; H04W 84/06

(57) ABSTRACT

Provided a method and a system for increasing system capacity in a multibeam satellite communication system. A signal transmission method of a multilayer-based multibeam structure of a satellite communication system may include generating a multilayer-based multibeam structure; selecting two or more layers for forming a single frequency selective channel; generating a transmission signal by applying the same channel encoding scheme to the two or more selected layer; and transmitting the transmission signal.

### CROSS-REFERENCE TO RELATED APPLICATION

This application claims the priority benefit of Korean Patent Application No. 10-2015-0031553 filed on Mar. 6, 2015, in the Korean Intellectual Property Office, the disclosure of which is incorporated herein by reference.

### BACKGROUND

1. Field of the Invention

Embodiments relate to a method and a system for increasing system capacity in a multibeam satellite communication system.

2. Description of the Related Art

Multiple-input multiple-output (MIMO) using multiple antennas is currently considered as a method for multiplying system capacity in diverse terrestrial radio communication fields. MIMO uses two or more multiple antennas at both a transmitter and a receiver to reduce fading effect, to achieve high capacity and high speed, and to extend coverage. In particular, MIMO may improve channel capacity without increasing a frequency bandwidth and transmission power.

Performance gains obtained by application of MIMO may include a space diversity gain, a spatial multiplexing gain, and a beamforming gain.

A space diversity gain is a gain obtained by selecting the best signal among signals transmitted along parallel paths to achieve fading reduction effect and diversity effect. A space diversity gain is achieved, for example, by space-time block coding.

A space multiplexing gain is achieved by dividing a high-capacity information signal into a plurality of spatial streams and simultaneously multiplexing-transmitting the streams or by simultaneously multiplexing-transmitting different individual signals through a plurality of spatial paths, enabling high speed and high-capacity transmission.

Finally, as a beamforming gain, there are an array effect of maximizing an SNR of a desired reception signal among signals received through a multichannel via spatial signal processing when channel information is recognized and an interference elimination effect obtained by attenuating a path signal particularly having substantial interference among signals transmitted through a plurality of multipaths.

Such gains of MIMO in a terrestrial wireless communication system may be obtained from independency of channels between multiple antennas and between users crated from multiple path channels.

Considering a satellite channel environment of line of sight (LoS) having no multiple-path fading, a capacity increase effect from MIMO is insignificant in a conventional multibeam satellite communication system, and thus there is a limitation in application of MIMO to the multibeam satellite communication system.

Embodiments may suggest a multilayer-based multibeam system structure for applying MIMO in a multibeam satellite communication system and an MIMO-based transmission method under the multibeam structure.

Further, since a diversity gain and a gain multiplexing gain may be obtained through multilayer-based satellite multibeam signal transmission, a reception SNR may be improved or maximum transmission rate may be enhanced.

### SUMMARY

An embodiment provides a multilayer-based multibeam system structure for applying multiple-input multiple-output (MIMO) in a multibeam satellite communication system and an MIMO-based transmission method under the multibeam structure.

According to an aspect, there is provided a signal transmission method of a multilayer-based multibeam structure of a satellite communication system, the method including generating a multilayer-based multibeam structure; selecting two or more layers for forming a single frequency selective channel; generating a transmission signal by applying the same channel encoding scheme to the two or more selected layer; and transmitting the transmission signal.

The generating of the transmission signal by applying the same channel encoding scheme to the two or more selected layers may include generating the transmission signal by applying a diversity scheme to the two or more selected layers.

The diversity scheme may include cyclic delay diversity (CDD).

The satellite communication system may have a frequency reuse factor of greater than 1.

According to another aspect, there is provided a signal transmission method of a multilayer-based multibeam structure of a satellite communication system, the method including generating a multilayer-based multibeam structure; forming an independent channel for a base layer using spatial multiplexing; forming an independent channel for an additional layer using spatial multiplexing in consideration of the base layer; generating a transmission signal spatially multiplexed for the base layer and the additional layer; and transmitting the transmission signal.

The generating of the multilayer-based multibeam structure may include generating a structure of the additional layer such that a structure boundary of the base layer is a beam central area.

The forming of the independent channel for the additional layer using spatial multiplexing in consideration of the base layer may include identifying a base layer channel transmitted in coverage of the additional layer; and forming the independent channel for the additional layer by applying an inter-adjacent beam frequency selective channel generating scheme to the transmission signal identified in the base layer channel.

The transmitting of the transmission signal may include transmitting different transmission signals through respective identified channels in the base layer and the additional layer.

The satellite communication system may have a frequency reuse factor of smaller than 1.

According to still another aspect, there is provided a signal transmission method of a multilayer-based multibeam structure of a satellite communication system, the method including generating a multilayer-based multibeam structure in which a base layer and an additional layer alternately overlap; forming independent channels for the base layer and the additional layer using spatial multiplexing; generating a transmission signal spatially multiplexed for the base layer and the additional layer; and transmitting the transmission signal.

The satellite communication system may have a frequency reuse factor of 1.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a beam design of a general multibeam satellite communication system.

FIG. 2 is a diagram illustrating a multilayer-based multibeam design structure having a frequency reuse of greater than 1 and a diversity-based satellite transmission method according to an embodiment;

FIG. 3 is a flowchart illustrating a signal transmission method in a multilayer-based multibeam satellite communication system having a frequency reuse of greater than 1 according to an embodiment;

FIG. 4 is a diagram illustrating a spatial multiplexing-based signal transmission method in a multilayer-based multibeam satellite system having a frequency reuse of smaller than 1 according to an embodiment;

FIG. 5 is a flowchart illustrating a signal transmission method in a multilayer-based multibeam satellite communication system having a frequency reuse of smaller than 1 according to an embodiment;

FIG. 6 is a diagram illustrating a method of realizing a frequency selective channel in a multilayer-based multibeam satellite communication system according to an embodiment;

FIG. 7 is a flowchart illustrating a signal transmission method in a multilayer-based multibeam satellite communication system having a frequency reuse of 1 according to an embodiment;

FIG. 8 illustrates a satellite transmitter which applies the same cyclic delay offset to all frames according to an embodiment; and

FIG. 9 is a diagram illustrating a method of applying a cyclic delay offset in a frequency domain according to an embodiment.

### DETAILED DESCRIPTION

Hereinafter, a signal transmission method in a multilayer-based multibeam satellite communication system will be described in detail with reference to the accompanying drawings.

The following embodiments may be modified variously. The following embodiments are not intended to limit the present invention but are construed as including all changes, equivalents and substitutions thereof.

The terminology used herein is for the purpose of describing particular embodiments only and is not intended to limit the embodiments. As used herein, the singular forms are intended to include the plural forms as well, unless the context clearly indicates otherwise. It will be further understood that the terms “include” and/or “have,” when used in this specification, specify the presence of stated features, integers, steps, operations, elements, components or combinations thereof, but do not preclude the presence or addition of one or more other features, integers, steps, operations, elements, components, or combinations thereof.

Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the description with reference to the accompanying drawings, like reference numerals denote like elements, and descriptions thereof will be omitted. When it is determined detailed description related to a related known technology may make the gist of the present invention unnecessarily ambiguous in describing the present invention, the detailed description will be omitted here.

An embodiment relates to a multilayer-based multibeam mobile satellite communication system to increase system capacity in the multibeam satellite communication system and a signal transmission method for increasing transmission rate in a multibeam structure thereof. Although the embodiment is described with reference to an LTE-based satellite communication system, the method may be applied to any other communication system having a multibeam.

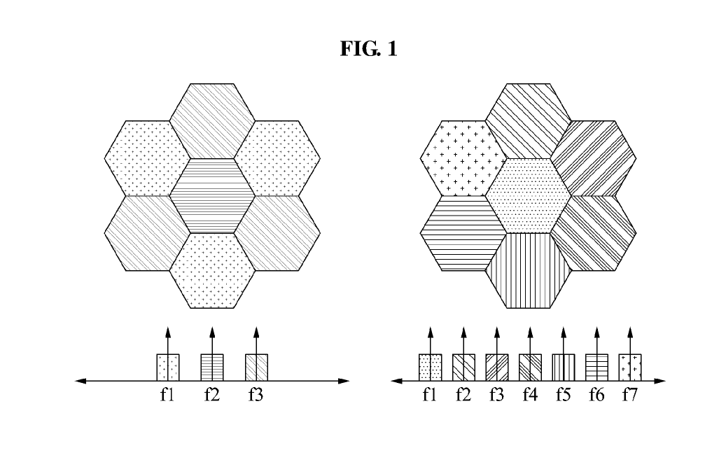

FIG. 1 illustrates a beam design of a general multibeam satellite communication system.

In FIG. 1, a left drawing illustrates a design structure with a frequency reuse of 3, and a right drawing illustrates a design structure with a frequency reuse of 7.

Since a frequency may be reused efficiently in a frequency reuse of 3 as compared with in a frequency reuse of 7, spectrum efficiency is high but comparatively substantial interference may occur from other beams using the same frequency.

Thus, a suitable frequency reuse of 1 or greater may be considered in view of a number of available carriers, required beam throughput, and a satellite antenna pattern of a satellite communication system.

The multibeam system of FIG. 1 has a limitation in forming a steep antenna beam pattern unlike a terrestrial mobile system and has an insignificant difference in receive power between a beam central area and a beam boundary area for providing a regular link budget regardless of a user position.

For example, the beam boundary area may be designed in a position with a beam width of 3 dB from the beam central area. That is, in terrestrial mobile communication, since a frequency reuse of 1 is used and a difference in receive power between the beam central area and the beam boundary area is highly significant due to path loss, carrier aggregation (CA) between adjacent beams may not be used. In multibeam satellite communication, however, since different carriers are used for adjacent beams and a difference in receive power between the beam central area and the beam boundary area is insignificant, carrier aggregation between multiple carriers having similar ranges of coverage may be used.

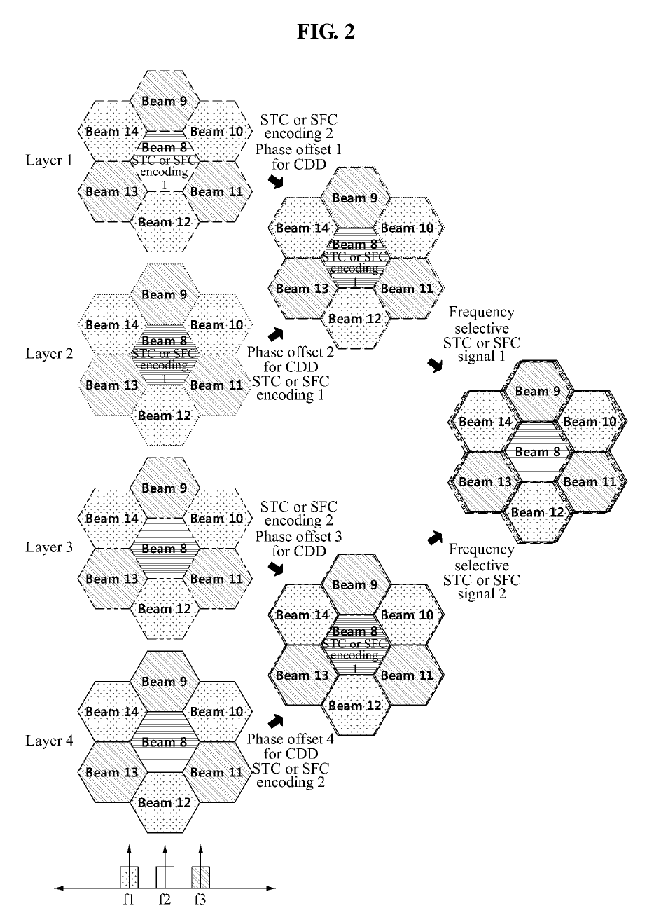

FIG. 2 is a diagram illustrating a multilayer-based multibeam design structure having a frequency reuse of greater than 1 and a diversity-based satellite transmission method according to an embodiment.

Although the embodiment is described with reference to a frequency reuse of 3, the same principle may also be applied to a case with a different frequency reuse value. Further, although four-layer 2×1 space-time coding (STC) or space-frequency coding (SFC)-based satellite transmission is considered, the same principle may be applied to a diversity scheme based on a different number of multilayers.

A frequency selective channel may be formed using the multilayer-based multibeam structure to apply a diversity scheme effectively operating in the frequency selective channel. In the embodiment, a greater number of multilayers may be required to form a plurality of particular frequency selective channels.

In FIG. 2, Layer 1 and Layer 2 are considered to form a single frequency selective channel, and Layer 3 and Layer 4 are considered to form another independent frequency selective channel. In the embodiment, cyclic delay diversity (CDD) may be applied to the multilayer-based multibeam structure in order to form the frequency selective channel. Here, in addition to CDD, any scheme may be applied to form a frequency selective channel, such as time delay transmission in a CDMA system.

Since Layer 1 and Layer 2 generate a single frequency selective channel, the same STC or SFC encoding is applied to Layer 1 and Layer 2. Likewise, the same STC or SFC encoding is applied to Layer 3 and Layer 4.

When a diversity scheme-applied signal is received from the multilayer-based multibeam structure, a terminal may apply a basic STC or SFC decoding mode as it is to receive the signal. When the signal is transmitted as above, a receiver terminal may acquire a diversity gain even with the same transmit power and thus secure a higher signal-to-noise ratio (SNR), thereby enabling high-speed transmission and increasing system capacity.

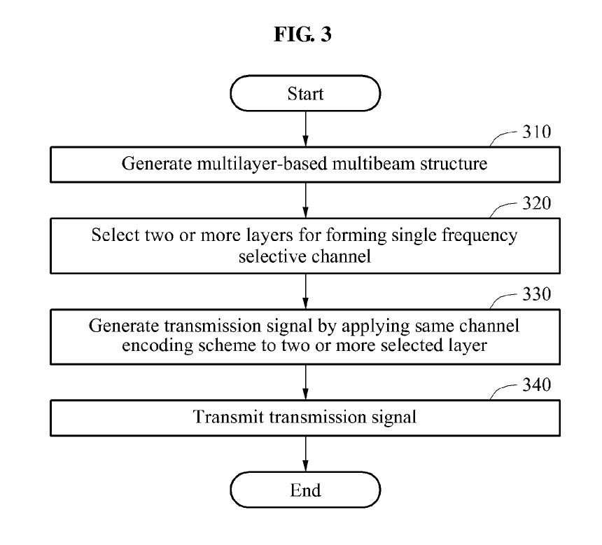

FIG. 3 is a flowchart illustrating a signal transmission method in a multilayer-based multibeam satellite communication system having a frequency reuse of greater than 1 according to an embodiment.

In operation 310, a multilayer-based multibeam structure may be generated.

In the embodiment, the multilayer-based multibeam structure is to form a particular frequency selective channel.

In operation 320, two or more layers may be selected to form a single frequency selective channel.

In the embodiment, layers to which the same diversity scheme is applied may be grouped, and a frequency selective channel may be generated by each group of layers. To form a frequency selective channel, a diversity scheme, such as CDD, may be applied to the multilayer-based multibeam structure.

According to the embodiment in FIG. 2, Layer 1 and Layer 2 may be selected for one layer group to generate a single frequency selective channel, and Layer 3 and Layer 4 may be selected for another layer group to generate another single frequency selective channel.

In operation 330, the same channel encoding scheme may be applied to the two or more selected layers to generate a transmission signal.

In the embodiment, a diversity scheme and a frequency selective channel generating scheme may be applied to each layer group to generate a transmission signal. For example, the same scheme selected from STC and SFC encoding schemes may be applied to the selected layers.

In operation 340, the transmission signal may be transmitted.

In the embodiment, a receiver may receive the transmission signal using a reception scheme corresponding to a diversity scheme used for a transmitter. For example, the receiver may receive the transmission signal by applying an STC or SFC decoding scheme.

The signal transmission method according to the embodiment may apply the diversity scheme and the frequency selective channel generating scheme in a different order, and may generate a transmission signal only by generating a frequency selective channel and transmit the transmission signal.

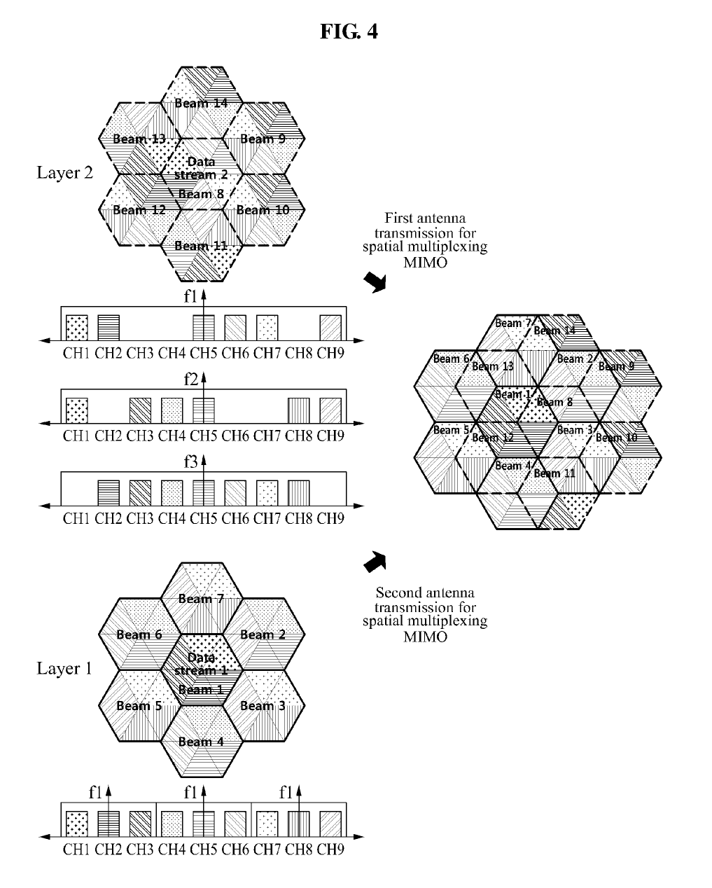

While FIGS. 2 and 3 illustrate diversity-based signal transmission methods in a multilayer-based multibeam satellite system having a frequency reuse greater than a basic frequency reuse of 1, FIG. 4 illustrates a spatial multiplexing-based signal transmission method in a multilayer-based multibeam satellite system having a frequency reuse smaller than a basic frequency reuse of 1.

FIG. 4 is a diagram illustrating a spatial multiplexing-based signal transmission method in a multilayer-based multibeam satellite system having a frequency reuse of smaller than 1 according to an embodiment.

In the embodiment, an independent channel between transmission antennas may be formed using a system with a multilayer-based multibeam structure to apply a spatial multiplexing technique effectively operating in the independent channel between the transmission antennas.

In the embodiment in FIG. 4, Layer 1 and Layer 2 may be considered to form an independent transmission channel. A signal transmitted in Layer 1 may be considered as a first transmission antenna signal for spatial multiplexing, and a signal transmitted in Layer 2 may be considered as a second transmission antenna signal for spatial multiplexing. Thus, the system may be considered as a 2×2 multiple-input multiple-output (MIMO) system for obtaining a spatial multiplexing gain, and any conventional 2×2 spatial multiplexing technique may be applied to the multibeam satellite system structure of FIG. 4.

When a signal transmitted from each transmission antenna for spatial multiplexing is transmitted to multibeams in each layer in the multilayer-based multibeam structure of FIG. 4, a spatial multiplexing gain may be obtained.

Here, CDD may be applied in view of an additional layer to form a frequency selective channel for spatially multiplexed transmission signals in each layer. For example, a multilayer-based multibeam structure having four layers is formed, in which two layers may be applied to form a frequency selective channel, and remaining two layers may be subjected to spatial multiplexing.

In the embodiment, unlike in the embodiment of FIG. 2, a multibeam signal transmitted to form a base layer and a multibeam signal additionally considered for spatial multiplexing need to be transmitted differently.

In the embodiment of FIG. 4, since a frequency reuse of 3 is used in the base layer, an entire bandwidth is divided for independent use by three beams so that beam 1 uses channels 1 to 3, beam 2 uses channels 4 to 6, and beam 3 uses channels 7 to 9. However, in a case of multibeams in an additional layer for spatial multiplexing, as shown in FIG. 4, each beam may be transmitted with a configuration of six different beams in order to transmit a signal independently from the base layer.

The multibeams in the additional layer for spatial multiplexing need transmitting in a broad band as compared with in the base layer. Here, in a case of the multibeams in the additional layer for spatial multiplexing, since a single channel signal is transmitted from two adjacent beams, the signal may be received with high sensitivity. Also, when a diversity scheme, such as CDD, is applied to a single channel, a frequency selective channel for the channel signal may be realized. For example, in FIG. 4, channel 1 (CH1) may be transmitted from beam 1 and beam 2 in an additional channel. That is, when CDD is applied to a channel 1 signal of beam 1 and beam 2, a frequency selective channel may be realized.

Since a spatial multiplexing technique using two layers is applied to the method illustrated in FIG. 4, the method may transmit two data streams, for example, stream 1 and stream 2, thereby increasing data rate basically by two times.

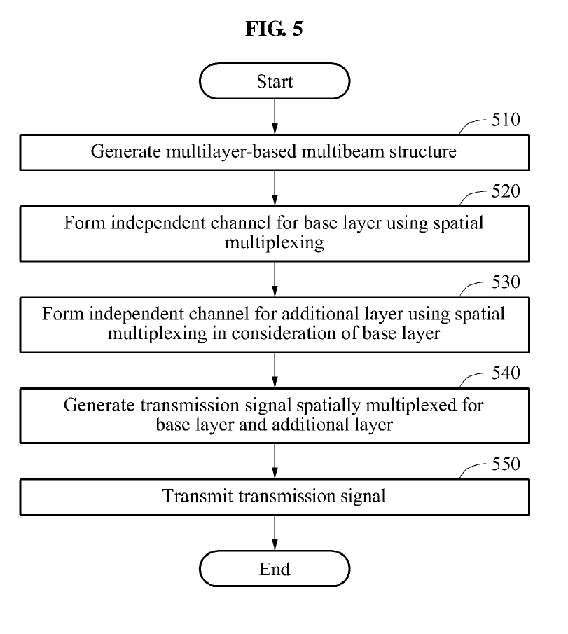

FIG. 5 is a flowchart illustrating a signal transmission method in a multilayer-based multibeam satellite communication system having a frequency reuse of smaller than 1 according to an embodiment.

In operation 510, a multilayer-based multibeam structure may be generated. The multilayer-based multibeam structure according to the embodiment is for spatial multiplexing and for generating a frequency selective channel.

The multilayer-based multibeam structure according to the embodiment may generate a structure of an additional layer such that a boundary of a base layer structure is a beam central area.

In operation 520, an independent channel may be formed for a base layer using spatial multiplexing.

In the embodiment, spatial multiplexing may be applied to a number of channels included in an entire bandwidth in the base layer according to a frequency reuse and a frequency selective channel may be generated, thereby forming the independent channel. Spatial multiplexing and a frequency selective channel generation scheme may be applied in a different order, and only spatial multiplexing may be used to generate a channel for signal transmission.

In operation 530, an independent channel may be formed for the additional layer using spatial multiplexing in consideration of the base layer.

In the embodiment, in order to transmit a signal in the additional layer independently from in the base layer, transmission may be performed with a different channel configuration from that of the base layer. In the additional layer, transmission in a broader band is needed for spatial multiplexing than in the base layer.

In operation 540, a spatially multiplexed transmission signal for the base layer and the additional layer may be generated.

The transmission signal in the embodiment may be transmitted differently according to the base layer and the additional layer. In the embodiment, a transmission signal may be generated through a different channel generated for each of the layers.

In operation 550, the transmission signal may be transmitted.

In the embodiment, a receiver receiving the transmission signal may receive the transmission signal using a reception scheme corresponding to a spatial multiplexing scheme used in a transmitter.

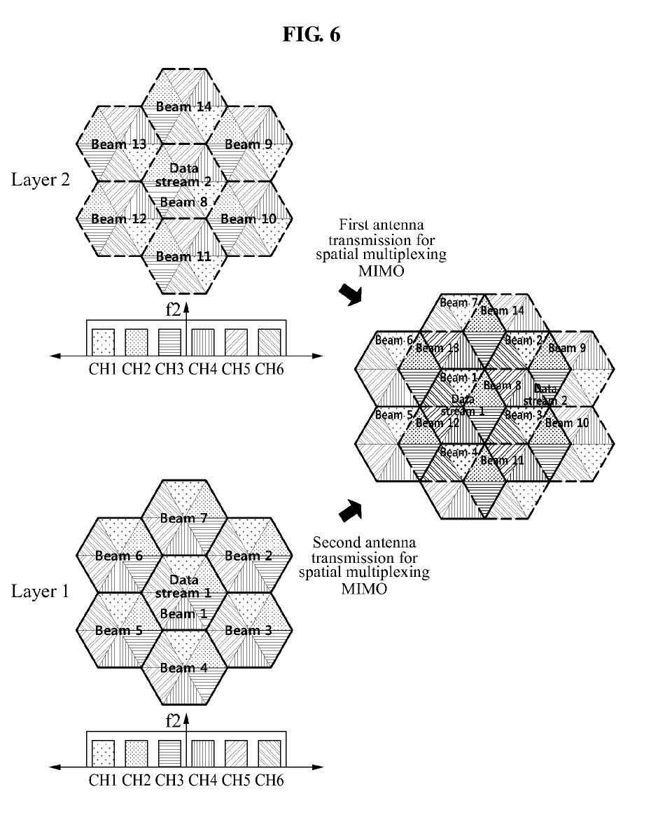

FIG. 6 is a diagram illustrating a method of realizing a frequency selective channel in a multilayer-based multibeam satellite communication system according to an embodiment.

The satellite communication system according to the embodiment has a frequency reuse of 1 and provides a multilayer-based multibeam satellite transmission method using spatial multiplexing. In FIG. 6, Layer 1 and Layer 2 are considered to form an independent transmission channel. A signal transmitted in Layer 1 may be considered as a first transmission antenna signal for spatial multiplexing, and a signal transmitted in Layer 2 may be considered as a second transmission antenna signal. The embodiment may correspond to a 2×2 MIMO system for obtaining a spatial multiplexing gain.

In the embodiment, the same channel configuration of a transmission bandwidth illustrated in FIG. 6 may be used for a base layer and an additional layer, and different spatial multiplexing schemes may be applied to form independent channels, thereby designing an alternately overlapping multilayer-based multibeam structure as shown in FIG. 6.

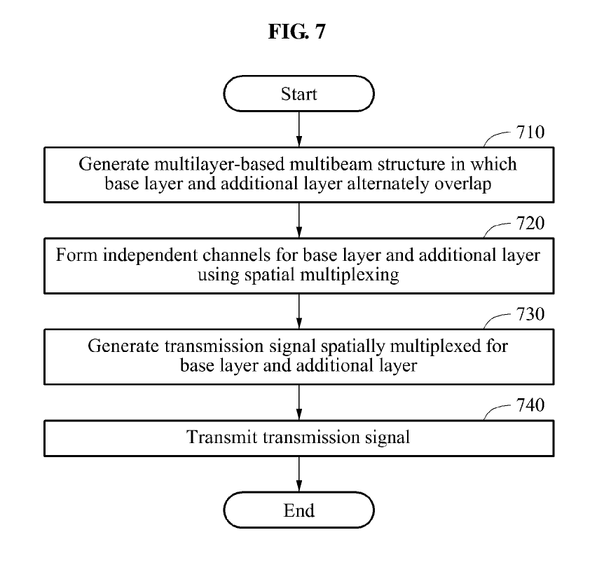

FIG. 7 is a flowchart illustrating a signal transmission method in a multilayer-based multibeam satellite communication system having a frequency reuse of 1 according to an embodiment.

In operation 710, a multilayer-based multibeam structure in which a base layer and an additional layer alternately overlap may be generated.

In the embodiment, an alternately overlapping multilayer-based multibeam structure may be generated in order to form independent channels in the same transmission bandwidth. In generating the multilayer-based multibeam structure according to the embodiment, a structure of an additional layer may be generated such that a boundary of a base layer structure is a beam central area.

In operation 720, independent channels may be formed for a base layer and the additional layer using spatial multiplexing.

In the embodiment, spatial multiplexing may be applied for the same layer and a frequency selective channel may be generated. Here, generating a frequency selective channel may be selectively performed. Further, CDD may be applied in consideration of the additional layer in order to form a frequency selective channel.

In operation 730, a spatially multiplexed transmission signal for the base layer and the additional layer may be generated.

The transmission signal in the embodiment may be transmitted differently according to the base layer and the additional layer. In the embodiment, a transmission signal may be generated through a different channel generated for each of the layers.

In operation 740, the transmission layer may be transmitted.

In the embodiment, a receiver receiving the transmission signal may receive the transmission signal using a reception scheme corresponding to a spatial multiplexing scheme used in a transmitter.

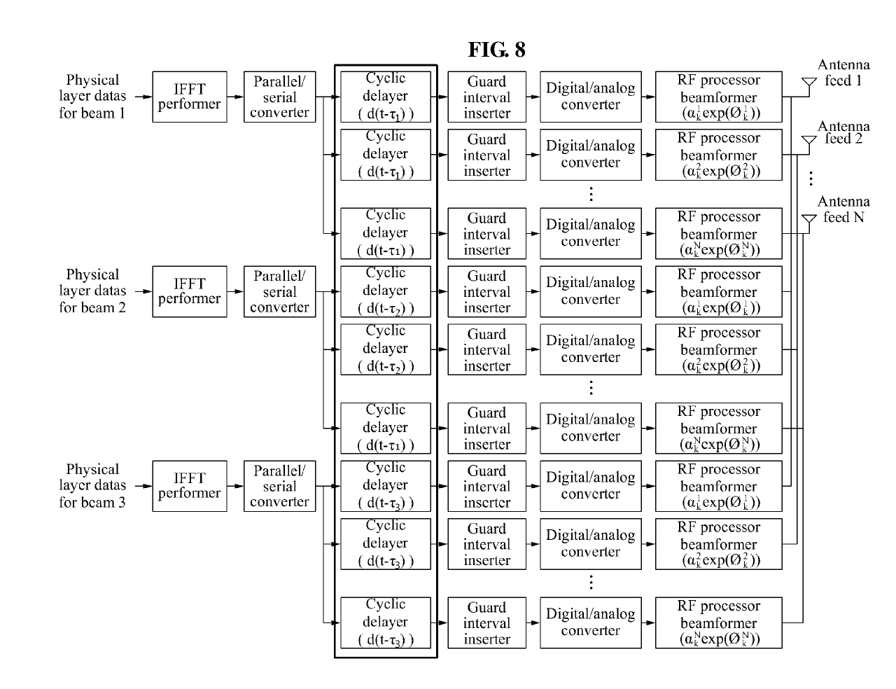

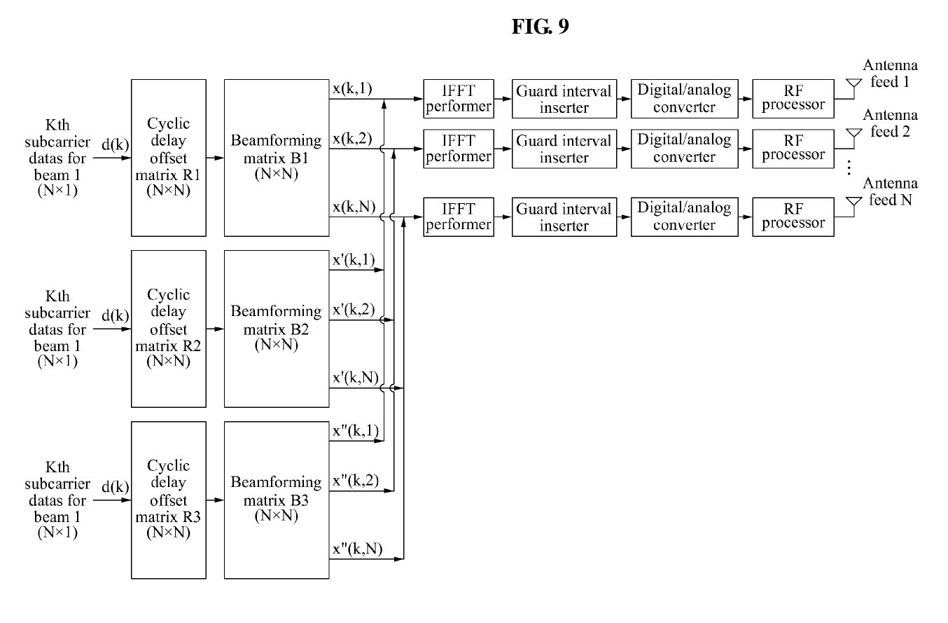

FIGS. 8 and 9 illustrate a method of realizing a frequency selective channel in a multilayer-based multibeam structure with reference to an LTE-based multibeam satellite system.

FIG. 8 illustrates a satellite transmitter which applies the same cyclic delay offset to all frames according to an embodiment.

In the embodiment, three cyclic delay offset delayers are needed to realize a frequency selective channel from three layers. As offset values applied to the delayers, three values to obtain a maximum diversity gain from the three cyclic delayers are selected.

The transmitter of FIG. 8 has a structure of applying a cyclic delay offset for generating frequency selective fading between beam signals in a time domain when signals for one user equipment ((UE) are simultaneously transmitted from a plurality of layer beams generated from a plurality of antenna feed groups.

The transmitter has the same structure as a conventional multibeam satellite communication system transmitter except for the cyclic delayers and may apply the cyclic delayers after inverse fast Fourier transform (IFFT). Physical layer data bits of each layer beam may be subjected to IFFT and then to insertion of a guard interval in the time domain.

A signal may be converted into an analog signal and subjected to a multibeam former, after which the signal may be transmitted through layer 1 beam, layer 2 beam, and layer 3 beam formed respectively through beam former 1, beam former 2, and beam former 3 from an antenna group of antenna feeds 1 to N.

In this case, since communication is achieved mostly through LOS between multibeam signals transmitted through a plurality of layer beams in a cooperative manner, channels between the layer beams and a user have a frequency-flat characteristic. Thus, reception signals from multibeams have no frequency selective characteristic, thus not obtaining a frequency diversity gain which can be obtained in an OFDMA-based terrestrial system.

To overcome this problem, a cyclic delay offset may be applied to each multibeam signal after IFFT. A cyclic delay offset applied in FIG. 8 may be applied either before or after IFFT.

As in the embodiment illustrated in FIG. 8, to artificially make a characteristic of a channel between each layer multibeam signal and a UE frequency-selective, different cyclic delay offsets are applied to antenna feed signals for the respective layer multibeams. Although layer beams 1, 2, and 3 are formed from a single antenna feed group in the embodiment, the same method may be applied when layer beams 1, 2, and 3 are formed from different antenna feed groups.

FIG. 9 is a diagram illustrating a method of applying a cyclic delay offset in a frequency domain according to an embodiment.

In the embodiment, a kth subcarrier data vector is transmitted from a satellite transmitter through a single antenna feed group or a plurality of antenna feed groups for each layer beam user. A transmitter for each layer beam applies a cyclic delay offset matrix Ri (i=1, 2, 3) having a diagonal matrix to a data signal transmitted through the kth subcarrier in each beam and multiply the signal by a beamforming matrix B1 to form a target beam.

A kth subcarrier signal in each of layer beams 1, 2, and 3 generated by this method may be mapped to a position of the kth subcarrier of IFFT and transmitted independently in each antenna feed. For example, a cyclic delay offset matrix R1 may have a diagonal matrix as follows.

$$R 1 = [ \begin{matrix}1 & … & 0 \\ ⋮ & ⋱ & ⋮ \\ 0 & … & {e}^{- j 2 π {τ}_{1} ( N - 1 ) k}\end{matrix} ] . \qquad [ Equation ]$$

A signal x(k) for each antenna feed group to which a cyclic delay offset and a digital beamforming algorithm are applied may be mapped to a kth subcarrier signal for IFFT of antenna feed elements in an antenna group forming each layer beam, be subjected to IFFT and RF processing, and be transmitted.

Here, selected cyclic delay offsets τ₁, τ₂, τ₃ are selected to maximize a diversity gain of a user receiving a signal through cooperative transmission by beams 1, 2, and 3 in a beam boundary area. For example, 0.2 pi/3 and 4 pi/3 may be selected.

The embodiment may suggest a multilayer-based multibeam system structure for applying an MIMO technique in a multibeam satellite communication system, and an MIMO-based transmission method under the multibeam structure.

Since a diversity gain and a gain multiplexing gain may be obtained through multilayer-based satellite multibeam signal transmission, a reception SNR may be improved or maximum transmission rate may be enhanced.

The above-described embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tapes; optical media such as CD ROMs and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits are combined or coupled in different forms and modes than as described above or be substituted or switched with other components or equivalents.

Thus, other implementations, alternative embodiments and equivalents to the claimed subject matter are construed as being within the appended claims.

What is claimed is:

1. A signal transmission method of a multilayer-based multibeam structure of a satellite communication system, the method comprising:
generating a multilayer-based multibeam structure;
selecting two or more layers for forming a single frequency selective channel;
generating a transmission signal by applying the same channel encoding scheme to the two or more selected layer; and
transmitting the transmission signal.

2. The method of claim 1, wherein the generating of the transmission signal by applying the same channel encoding scheme to the two or more selected layers comprises generating the transmission signal by applying a diversity scheme to the two or more selected layers.

3. The method of claim 2 wherein the diversity scheme comprises cyclic delay diversity (CDD).

4. The method of claim 1, wherein the satellite communication system has a frequency reuse factor of greater than 1.

5. A signal transmission method of a multilayer-based multibeam structure of a satellite communication system, the method comprising:
generating a multilayer-based multibeam structure;
forming an independent channel for a base layer using spatial multiplexing;
forming an independent channel for an additional layer using spatial multiplexing in consideration of the base layer;
generating a transmission signal spatially multiplexed for the base layer and the additional layer; and
transmitting the transmission signal.

6. The method of claim 5, wherein the generating of the multilayer-based multibeam structure comprises generating a structure of the additional layer such that a structure boundary of the base layer is a beam central area.

7. The method of claim 5, wherein the forming of the independent channel for the additional layer using spatial multiplexing in consideration of the base layer comprises:
identifying a base layer channel transmitted in coverage of the additional layer; and
forming the independent channel for the additional layer by applying an inter-adjacent beam frequency selective channel generating scheme to the transmission signal identified in the base layer channel.

8. The method of claim 6, wherein the transmitting of the transmission signal comprises transmitting different transmission signals through respective identified channels in the base layer and the additional layer.

9. The method of claim 5, wherein the satellite communication system has a frequency reuse factor of smaller than 1.

10. A signal transmission method of a multilayer-based multibeam structure of a satellite communication system, the method comprising:
generating a multilayer-based multibeam structure in which a base layer and an additional layer alternately overlap;
forming independent channels for the base layer and the additional layer using spatial multiplexing;
generating a transmission signal spatially multiplexed for the base layer and the additional layer; and
transmitting the transmission signal.

11. The method of claim 10, wherein the generating of the multilayer-based multibeam structure in which the base layer and the additional layer alternately overlap comprises generating a structure of the additional layer such that a structure boundary of the base layer is a beam central area.

12. The method of claim 10, wherein the transmitting of the transmission signal comprises transmitting the transmission signal in the same manner in the base layer and the additional layer.

13. The method of claim 10, wherein the satellite communication system has a frequency reuse factor of 1.
